(19) United States
(12) Patent Application Publication
(10) Pub. No.: US 2025/0150338 A1
(43) Pub. Date: May 8, 2025

(54) SYSTEMS AND METHODS FOR DYNAMIC TRUST-BASED NETWORK ARCHITECTURES

(71) Applicant: CABLE TELEVISION LABORATORIES, INC., Louisville, CO (US)

(72) Inventors: LUTHER E. SMITH, Fort Lupton, CO (US); BRIAN A. SCRIBER, Lafayette, CO (US); JASON W. RUPE, Lafayette, CO (US); SUNDAR R. SRIRAM, Aurora, CO (US)

(21) Appl. No.: 18/940,066

(22) Filed: Nov. 7, 2024

Related U.S. Application Data
(60) Provisional application No. 63/547,790, filed on Nov. 8, 2023.

(51) Int. Cl. H04L 41/0806; H04L 9/40; H04L 45/851

(52) U.S. Cl. CPC H04L 41/0806; H04L 45/851; H04L 63/0823; H04L 63/105; H04L 63/108

(57) ABSTRACT

A system for dynamic trust-based network architectures is provided. The system includes a computer device programmed to: a) store plurality of records for a plurality of network elements, wherein each record of the plurality of records includes a current status of the corresponding network element of the plurality of network elements; b) receive a request for a set of network elements for data transmission; c) scan the plurality of records for a plurality of available network elements for the request; d) select a first set of network elements to meet the request from the plurality of network elements based upon the current status of each of the plurality of available network elements; e) generate a response to the request based upon the first set of network elements; f) receive a confirmation of the response; and g) configure the first set of network elements to complete the data transmission.

### CROSS REFERENCE TO RELATED APPLICATIONS

This application claims priority to U.S. Provisional Application No. 63/547,790, filed Nov. 8, 2023, which is hereby incorporated by reference in its entirety.

### BACKGROUND

The field of the invention relates generally to dynamically building trust-based architectures, and more specifically, to systems and methods of dynamically managing multiple roots of trust.

Secure and efficient communication requires trust in not just the source and destination, but also in all of the network components used in these communications. Untrusted networks and components lead to compromised networks.

To create a trusted interconnected system, IPSec (Internet Protocol Security) tunnels could be used; however, this methodology requires manual setup. This could impact network component plug and play deployment. This could also introduce maintenance issues based upon the network impacts. PKI (public key infrastructure) trust roots could be put into place to address the IPSec tunnels. However, this would require Certificate Authorities, root trust chains, certificate issuance and revocation, and trust certificates would have to be dealt with in a uniform manner across networks and trust providers. This would increase costs and results in having as few as one point of failure.

### BRIEF DESCRIPTION

A system is provided. The system includes at least one computer device including at least one processor in communication with at least one memory device. The at least one memory device includes computer instructions that cause the at least one processor to: a) store plurality of records for a plurality of network elements, wherein each record of the plurality of records includes a current status of the corresponding network element of the plurality of network elements; b) receive a request for a set of network elements for data transmission; c) scan the plurality of records for a plurality of available network elements for the request; d) select a first set of network elements to meet the request from the plurality of network elements based upon the current status of each of the plurality of available network elements; e) generate a response to the request based upon the first set of network elements; f) receive a confirmation of the response; and g) configure the first set of network elements to complete the data transmission. The system may include additional, less, or alternate functionality, including that discussed elsewhere herein.

A method is provided. The method is implemented on at least one computer device including at least one processor in communication with at least one memory device. The method includes: a) storing plurality of records for a plurality of network elements, wherein each record of the plurality of records includes a current status of the corresponding network element of the plurality of network elements; b) receiving a request for a set of network elements for data transmission; c) scanning the plurality of records for a plurality of available network elements for the request; d) selecting a first set of network elements to meet the request from the plurality of network elements based upon the current status of each of the plurality of available network elements; e) generating a response to the request based upon the first set of network elements; f) receiving a confirmation of the response; and g) configuring the first set of network elements to complete the data transmission. The method may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates an exemplary computer network in accordance with at least one embodiment of the disclosure.

FIG. 2 illustrates a dynamic trust architecture (DTA) system for managing network element trust for the network shown in FIG. 1, in accordance with at least one embodiment of the disclosure.

FIG. 3 illustrates an example system for dynamically authenticating network elements shown in FIG. 1, in accordance with at least one embodiment of this disclosure.

FIG. 4 illustrates a timing diagram of a process for adding a network element shown in FIG. 1 to the distributed ledger.

FIG. 5 illustrates a timing diagram of a process for gaining access to one or more network elements shown in FIG. 1 on the network shown in FIG. 1.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random-access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable and include any computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

For the purposes of this disclosure a distributed ledger includes a technological infrastructure and protocols that allow simultaneous access, validation, and record updating across a networked database. Data in digital ledgers is stored securely and accurately using cryptography. The data can be accessed using “keys” and cryptographic signatures. Once the information is stored, it can become an immutable database; the rules of the network, written into the coding of the database programming, govern the ledger. Every device on a distributed ledger network stores a copy of the ledger. These devices are called nodes-a network can have any number of nodes. Any changes to the ledger, such as moving data from one block to another, are recorded across all nodes. Because each node has a copy of the ledger, each one publishes its version with the latest transactions.

The field of the disclosure relates generally to dynamically building trust-based architectures, and more specifically, to systems and methods for dynamically managing multiple roots of trust. This disclosure describes a dynamic trust architecture (DTA) system that allows managing multiple roots of trust. In the exemplary embodiment, the DTA system includes a jurisdiction based distributed ledger. The DTA system allows for quick identification of independent components or elements that are introduced into systems before they are put into service to prevent the introduction of malicious code or intrusion vectors before the component(s) become an active part of the network system. This would allow for adding components or elements to be added and/or deployed in the plug-and-play systems, while ensuring trust and preventing untrusted components from being enabled in the system, thus preventing intrusions or other harmful impacts.

Entities, such as, but not limited to, governments, network operators, and municipalities need to dynamically draw trust boundaries amongst ecosystems based upon vendors and/or aggregators of network components. For example, an entity may need a network slice, or other temporary network construct, to connect two or more locations for secure communication. For secure communications, the entity needs to be able to trust every network component or element to be used in the connection. Furthermore, the trust must be short-lived with credentials that are unique and immutable because they will exist in containers and virtual environments. Existing interface boundary standards defining subsystems, components, and/or elements are nascent. They do not include standardized authentication mechanisms that enable plug-and-play with these network components. Additionally, to handle future security concerns, these network components must support Zero Trust Architectures in both authN and authZ using assignable post-quantum credentials.

For the purposes of this discussion, 5G network slicing is a network architecture that enables the multiplexing of virtualized and independent logical networks on the same physical network infrastructure. Each network slice is an isolated end-to-end network tailored to fulfill diverse requirements requested by a particular application. This technology assumes a central role to support 5G mobile networks that are designed to efficiently embrace a plethora of services with very different service level requirements (SLR). The realization of this service-oriented view of the network leverages on the concepts of software-defined networking (SDN) and network function virtualization (NFV) that allow the implementation of flexible and scalable network slices on top of a common network infrastructure.

From a business model perspective, each network slice is administrated by a mobile network operator (MNO). The infrastructure provider (the owner of the telecommunication infrastructure) leases its physical resources to the MNOs that share the underlying physical network. According to the availability of the assigned resources, an MNO can autonomously deploy multiple network slices that are customized to the various applications provided to its own users. Accordingly, network slicing emerges as an essential technique in 5G networks to accommodate such different and possibly contrasting quality of service (QOS) requirements exploiting a single physical network infrastructure.

The basic idea of network slicing is to “slice” the original network architecture in multiple logical and independent networks that are configured to effectively meet the various services requirements. To quantitatively realize such concept, several techniques are employed, including network functions, virtualization, and orchestration. Network functions express elementary network functionalities that are used as “building blocks” to create every network slice. Virtualization provides an abstract representation of the physical resources under a unified and homogeneous scheme. In addition, it enables a scalable slice deployment relying on NFV that allows the decoupling of each network function instance from the network hardware it runs on. Orchestration is a process that allows coordination of all the different network components that are involved in the life cycle of each network slice. In this context, SDN is employed to enable a dynamic and flexible slice configuration.

For the purposes of this application, a network element is a hardware or software element that is used in the operation of a network. Examples of network elements include, but are not limited to, routers, hubs, switches, repeaters, transceivers, transmitters, receivers, computer devices, virtual network functions, and/or any other logical elements used in operation of the network.

For the purposes of this application, the goal is to ensure proper trust of each network device or component that will be used in the network slice. This includes identifying and monitoring the risk levels with each component or element. This allows aggregators, MNOs, and others to organize and schedule network slices for building experiences for a period of time. An example experience may include, but is not limited to, connecting a series of offices for a video conference, such as an all-hands meeting. While the present disclosure describes these systems and methods for 5G networks, one having skill in the art would understand that other networks, both wired and wireless, may be used with this disclosure.

In at least one embodiment, the DTA system is configured to analyze a computer network to determine where different network elements are deployed. Then the DTA system determines a trust level associated with each of the network elements. The trust level may be based upon one or more of known device identity, current firmware version(s), software bills of material (SBOM), change versions, maintenance history, testing history, secret source, validation history, and/or current software version(s), as well as whether or not the element has been authenticated and/or authorized and by whom. The DTA system stores the trust level and other information about the network elements. In at least one embodiment, the DTA system stores the trust level and other information in a distributed ledger, such as, but not limited to, blockchain. The DTA system stores the information in a distributed ledger so that the information is immutable. Furthermore, the distributed ledger allows for a time freeze on the information and allows the system and/or users to look at the current state of every stored device at a plurality of historical points in time and allows for taking a snapshot of the network. This may be useful for reporting the state of the network, such as for the Cyber Incident Reporting for Critical Infrastructure Act. The stored information allows the DTA system to determine routes of trust that would be able to deploy digital certificates, such as via PKI, to network elements and be able to tie those network elements to their history, such as their supply chain and current state. This history may include the answers to questions, such as, but not limited to, does your supply chain ever go through country X, if so, what is in the SBOM (software bill of materials), who worked on it, who has seen it, where does the secret for the certification come from (e.g., 3GPP), who has tested the product and validated that it meets the requirements and operating parameters for such a network element or device, has it been updated recently, what were the updates, and other information as needed.

Furthermore, the systems and methods described herein work well if the trust mechanism (i.e., digital certificate) is short-lived (e.g., lasts six months). This requires the system to regularly revisit each network element to confirm that it is up to date. Furthermore, the systems and methods described herein work well with ecosystems that support generating and sending push notifications and updates. If the systems and methods herein can suggest that network devices execute one or more updates to allow them to be up to date and therefore be authenticated.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

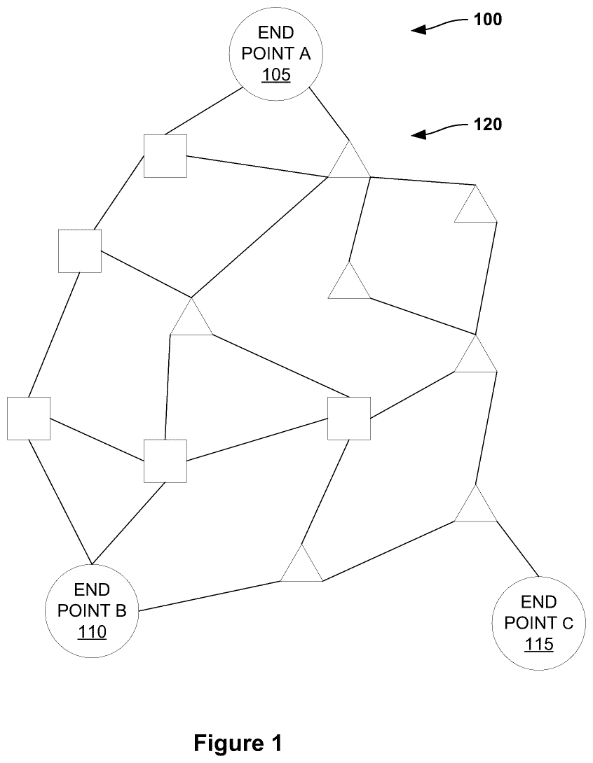

FIG. 1 illustrates an exemplary computer network 100 in accordance with at least one embodiment of the disclosure. Network 100 includes a plurality of endpoints A, B, and C 105, 110, and 115, respectively, with a plurality of network elements 120 connecting the endpoints A, B, and C 105, 110, and 115. The plurality of network elements 120 include authenticated network elements 125 and unauthenticated network elements 130.

In a first example, the DTA server 210 analyzes the network elements 120 of the computer network 100 to determine a trusted path between endpoints A 105 and B 110. The DTA server 210 plots a path from endpoint A 105 to endpoint B 110 using only authenticated network elements 125. This path only requires three authenticated network elements 125. In a second example, the DTA server 210 analyzes the network elements 120 of the computer network 100 to determine a path between endpoints A 105 and C 115. However, the shortest path is four unauthenticated network elements 130. And there is no path of just authenticated network elements 125. Accordingly, the DTA server 210 may determine that there is no authenticated path from endpoint A 105 to endpoint C 115. Depending on setting, the DTA server 210 may select the shortest path of four unauthenticated network elements 130, the DTA server 210 may select the path of five authenticated network elements 125 and two unauthenticated network elements 130, or the DTA server 210 may state that there is no safe path and request additional information. In some embodiments, the DTA server 210 determines whether or not to risk an unauthenticated network element 130 based upon a risk analysis.

In some situations, the DTA server 210 must include one or more unauthenticated network elements 130 in the path between the endpoints 105, 110, and 115. In these situations, the DTA server 210 determines the risk for each unauthenticated network element 130 and determines which unauthenticated network elements 130 to use based upon the associated risks. In some embodiments, the unauthenticated network elements 130 are missing some information to be able to allow them to become authenticated network elements 125. Accordingly, the DTA server 210 may determine whether or not the missing elements are important when determining whether or not to route messages through those unauthenticated network elements 130.

In at least one embodiment, the DTA server 210 is configured to analyze the unauthenticated network elements 130 and determine whether or not to authenticate them based on their settings as described herein.

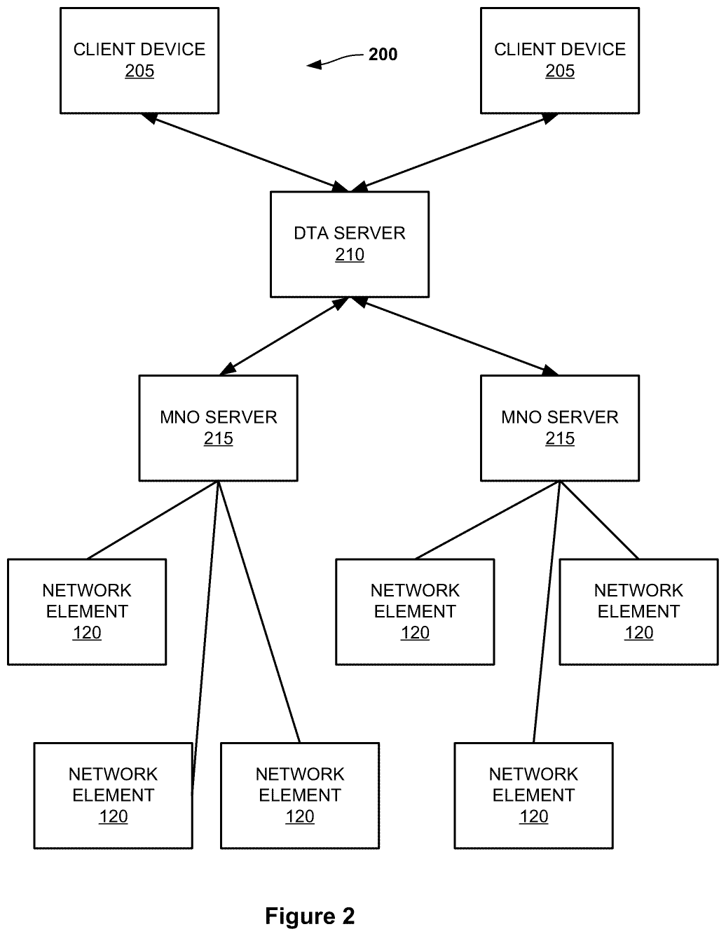

FIG. 2 illustrates a dynamic trust architecture (DTA) system 200 for managing network element trust for the network 100 (shown in FIG. 1), in accordance with at least one embodiment of the disclosure.

In the exemplary embodiment, the DTA system 200 is in communication with one or more client devices 205. These client devices 205 are computer devices associated with users that may be requesting specific network experiences, such as, but not limited to, customer network slices. The DTA system 200 also includes a dynamic trust architecture (DTA) server 210 (also known as a DTA computer device 210). The DTA server 210 is configured to monitor the computer network 100 and the network elements 120 therein. In addition, the DTA server 210 is also in communication with one or more MNO servers 215 associated with mobile network operator (MNO). The MNO servers 215 each control a plurality of network elements 120, where the MNO servers 215 are configured to control and configure the network elements 120 to execute virtual machines and virtual network functions (VNF), such as network slice selection function (NSSF).

In some embodiments, the MNO servers 215 monitor the network elements 120 and store information about the current status of those network elements 120.

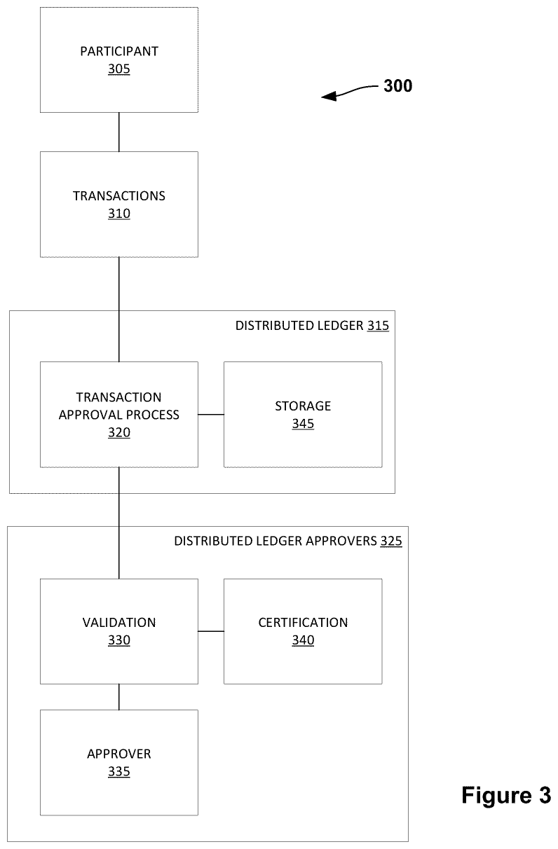

FIG. 3 illustrates an example system 300 for dynamically authenticating network elements 120 (shown in FIG. 1), in accordance with at least one embodiment of this disclosure. In at least one example, system 300 is configured for tracking network elements 120 in a network 100 to allow users to efficiently and safely use the network 100. In some of these embodiments, the network elements 120 are provided by multiple network providers, such as, but not limited to, cable providers, mobile network providers, wireless providers, wide area networks, enterprise networks, and/or other networks.

In the example embodiment, a participant, using a computer device, 305 transmits one or more transactions 310 to be executed for authenticated or unauthenticated network elements 125 or 130 (both shown in FIG. 1). Examples of transactions 310 include create/genesis, updates, and burn. A create/genesis transaction 310 is for adding a new authenticated network element 125. The new network element 120 may be new to the network, or it could have just been upgraded to meet the requirements to become authenticated. An update transaction 310 updates information about one or more authenticated network elements 125. The update information could include, but is not limited to, changes in software or hardware versions, new connections, new availability information and/or any other update as needed for this system 300. A burn transaction 310 is for removing a network element 120. For example if the network element 120 was removed from the network 100 or destroyed, such as in a lightning strike.

The transactions 310 are transmitted to a distributed ledger 315. The distributed ledger 315 is a central part of the system 300, because it provides an immutable record of the network elements 120 and their statuses at a plurality of points in time. The distributed ledger 315 can then be used to determine snapshots of the network 100 at different points in time. The distributed ledger 315 can also be used as a searchable database of current network elements 120 and their corresponding statuses.

The distributed ledger 315 routes the transactions 310 to its transaction approval process 320. The transaction approval process 320 analyzes each transaction and then forwards that transaction to the corresponding distributed ledger approvers 325. These approvers 325 work to ensure that the transactions 310 are accurately analyzed and determine whether or not to approve placing the transactions 310 in the distributed ledger 315.

In the example embodiment, the transactions 310 go through validation 330, to determine if the transactions 310 are valid. Is the participant 305 approved to make these transaction 310? Are the network elements 120 associated with the transactions 310 appropriate for those transactions 310, etc.? In the example embodiment, one or more approvers 335 review the validation results to determine whether or not to approve the transaction 310. In some embodiments, the approver 335 is a person who analyzes transaction 310 as a part of their participation with the distributed ledger 315. In other embodiments, the approver 335 is one or more computer devices programmed to analyze and approve the transactions 310 for adding them to the digital ledger 315 using complicated algorithms to determine whether or not the network element 120 in question meets the requirements to become authenticated.

In the example embodiment, if the transaction 310 is validated and approved, the system 300 adds a certification 340 to the transaction 310. For a create/genesis transaction 310, the certification 340 is for the corresponding network element 120 and indicates that it is now an authenticated network element 125. For an update transaction 310 the certification 340 is to show that the changes to the network element 120 have been authenticated and that it is an authenticated network element 125. For the burn transaction 310, the certification 340 is revoked for that network element 120. In all of these examples, some or all of the certification information is stored in the distributed ledger 315.

In the example embodiment, the transaction 310, the validation, the approval, and the certification 340 are all put into storage 345 in the distributed ledger 315.

In the example embodiment, some information in the distributed ledger 315 is stored in a manner to allow others to view freely. Other information is then stored in an encrypted manner to prevent unauthorized access.

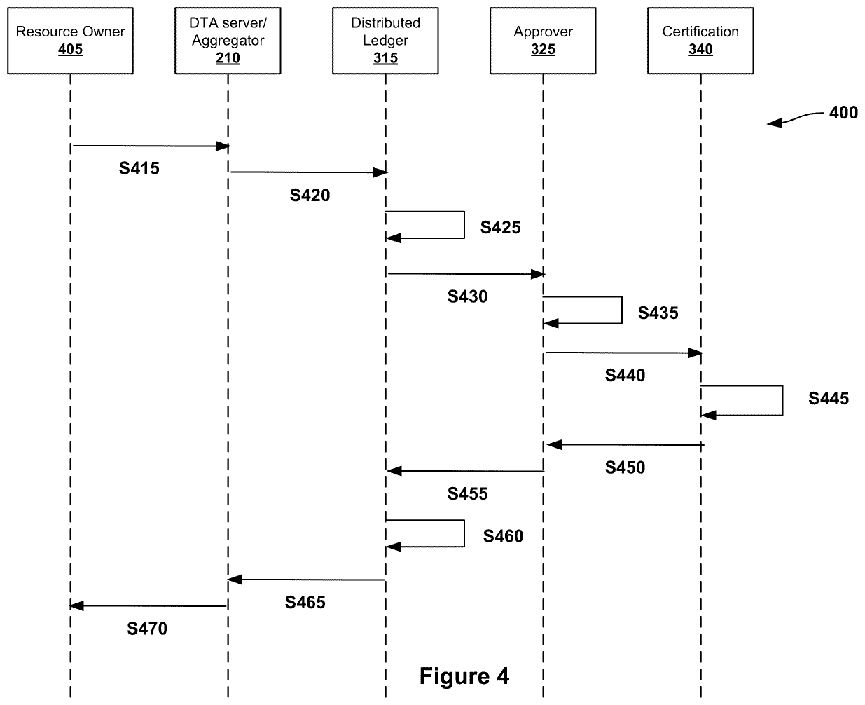

FIG. 4 illustrates a timing diagram of a process 400 for adding a network element 120 (shown in FIG. 1) to the distributed ledger 315.

In the example embodiment, the resource owner, using a computer device, 405 transmits S415 a message to an aggregator/DTA server 210. In some embodiments, the resource owner 405 is the participant 305 (shown in FIG. 3). In some further embodiments, the resource owner 405 is associated with the MNO server 215 (shown in FIG. 2). The resource owner 405 is responsible for the network element 120 in question. In some embodiments, the DTA server 210 is also known as an aggregator 210 for aggregating information about the network 100. In some embodiments, the message is a transaction 310 (shown in FIG. 3).

In the example embodiment, the message transmitted in step S415 includes information about the network element 120, such as, but not limited to, identification information, location information, software version information, firmware version information, supply chain information for the network element 120 and any sub-elements, availability information, and/or any other information desired to authenticate the network element 120. For example, the network element 120 may only be available for two weeks until the network element 120 will be in use for a pre-planned project/use.

In the example embodiment, the DTA server 210 forwards S420 the message to the distributed ledger 315. The distributed ledger 315 analyzes S425 the message and the information about the network element 120. The distributed ledger 315 submits S430 the message to the approver 325. The approver 435 validates and approves S435 the message and information about the network element 120. The approver 325 requests S440 authentication from the certification module 340. The certification module 340 generates S445 the certification information for the network element 120. The certification module 340 submits S450 the certification information to the approver 325. The approver 325 submits S455 the certification information, along with the validation and approval information to the distributed ledger 315. In the example embodiment, the certification is temporary with a short time frame, such as, but not limited to, six months. Before this certification expires, the update transaction 310 will need to be performed to keep the certification fresh. This update transaction 310 may check to see if all of the rules and requirements are met by the network element 120 to be authenticated. For example, if a version of software is later determined to have a vulnerability, the approver 325 checks to ensure that the authenticated network element 125 does not have the vulnerable software version before applying the certification module 340.

If the message is for a create/genesis transaction 310, the distributed ledger 315 store S460 the network element 120, along with its certification information, authentication information, and validation information, effectively adding the network element 120 as an authenticated network element 125.

If the message is for an update transaction 310, the distributed ledger 315 store S460 updated information for the network element 120, along with its certification information, authentication information, and validation information, effectively updating the network element 120 as an authenticated network element 125. In some embodiments, the updating of the network element 120 changes it from an unauthenticated network element 130 to an authenticated network element 125.

If the message is for a burn transaction 310, the distributed ledger 315 store S460 removal of the network element 120, along with its certification information, authentication information, and validation information, effectively removing the network element 120 as an authenticated network element 125.

In the example embodiment, if the network element 120 is not approved, then the distributed ledger 315 stores the unauthenticated network element 130 with its current parameters and status. This includes if the network element 120 was previously authenticated, but is not longer considered authenticated.

In some embodiments, the distributed ledger 315 provides S465 confirmation of the completion of the transaction 310 to the DTA server 210, which may then forward S470 the confirmation to the resource owner 405. In some embodiments, the DTA server 210 keeps records of the current states of the network elements 120 on the network 100.

In some embodiments, DTA servers 210, MNO servers 215, or other devices are used to analyze the available network elements 120 and their current statuses. In these embodiments, DTA servers 210, MNO servers 215, or other devices execute one or more functions to generate a list of the available authenticated network elements 125 and the list of unauthenticated network elements 130. The DTA servers 210, MNO servers 215, or other devices may then use those unauthenticated network elements 130 to determine what steps are needed to make those unauthenticated network elements 130 become authenticated network elements 125. In some situations, the unauthenticated network elements 130 needs to be analyzed by process 400. In other situations, the unauthenticated network elements 130 need to be upgraded, updated, or have configuration changes made to bring them in line to be authenticated. In these embodiments, the DTA servers 210, MNO servers 215, or other devices notifies the appropriate users to ensure those changes are made. In some of these embodiments, DTA servers 210, MNO servers 215, or other devices issue work orders to make the needed changes to the unauthenticated network elements 130.

In some further embodiments, DTA servers 210, MNO servers 215, or other devices is able to perform searches on the listing of authenticated network elements 125 to determine if any authenticated network elements 125 have certifications that are about to expire (e.g., in 12 hours, or in 6 months, etc.).

In the example embodiment, DTA servers 210, MNO servers 215, or other devices execute one or more functions that provides a list of trust devices, aka authenticated network elements 125. These authenticated network elements 125 are configured with parameters of trust, such that each is certified to create a level of trust with those devices based upon them meeting a rules structure or complicated algorithm that indicates that a trust risk assessment was successfully performed on each authenticated network element 125.

In at least one embodiment, during an initial inventory of network elements 120, DTA servers 210, MNO servers 215, or other devices may perform process 400 on a plurality of network elements 120 to build a full listing of the available network elements 120 and their current statuses. At the completion of this initial inventory, the digital ledger 315 includes a listing of authenticated network elements 125. The digital ledger 315 may also include a listing of all unauthenticated network elements 130 and their current attributes. The DTA servers 210, MNO servers 215, or other devices may then use the listing of unauthenticated network elements 130 to determine the needed steps to update and upgrade the unauthenticated network elements 130.

In some embodiments, the DTA servers 210, MNO servers 215, or other devices are able to search the distributed ledger 315 to determine inventories for different companies, enterprises, regions, or other groupings with filters to determine current statuses of network elements 120 in different domains. These inventories can be used to look at different networks 100 and determine where the different network elements 120 are deployed, what are the risks for the network 100, and then generate reports. For example, if there is a network element 120 with a sub-element that was changed, the system 300 tracks that and tracks when that change was made. In some embodiments, a flag may be stored to indicate the change.

In some embodiments, different authenticated network elements 125 may restrict which other network elements 120 that they work with. For example, a secure authenticated network element 125 can indicate to the DTA servers 210, MNO servers 215, or other devices, that the authenticated network element 125 will not work with unauthenticated network elements 130.

In some embodiments, DTA servers 210, MNO servers 215, or other devices support push notifications and updates. This allows the DTA servers 210, MNO servers 215, or other devices to send updates to network elements 120 to bring the network elements 120 up to date. Furthermore, if the DTA servers 210, MNO servers 215, or other devices learn that a network element 120 is not authenticated because the network element 120 has an incorrect software or firmware version, the DTA servers 210, MNO servers 215, or other devices pushes the update to the corresponding network element 120 and then triggers process 400 for that network element 120 when the update is complete to make the network element 120 authenticated.

In some embodiments, the certification module 340, validation 330, and/or approver 335 determines a level of trust for the network element 120 being analyzed. For example, there could be different requirements for different levels of trust for network elements 120, such as based on software, firmware, and hardware versions. Different configurations for network elements 120 could be considered to be more trustworthy and thus given a higher level of trust. This level of trust may be a score that is stored in the distributed ledger 315. This level of trust could also be a different certification that is assigned to the network element 120 and stored in the distributed ledger 315. For example, a first configuration may describe a first level of trust that is assigned a first certification document, while a second configuration may describe a second level of trust that is assigned a second certification document. The first and second certification documents may use different encryption and/or be issued by different certification authorities.

In some embodiments, the DTA servers 210, MNO servers 215, or other devices use the distributed ledger 315 to generate current inventory listings to comply with governmental reporting. The distributed ledger 315 allows the DTA servers 210, MNO servers 215, or other devices to determine the current status of the network elements 120 at different points in time, so, for example, the report may be generated for a time when a breach occurred or a vulnerability was discovered. For example, the Cyber Incident Reporting for Critical Infrastructure Act has requirements for different reports that are due for different types of attacks that happen. The inventory capabilities with the present system 300 allow for reporting about the locations of specific types of devices in different networks 100.

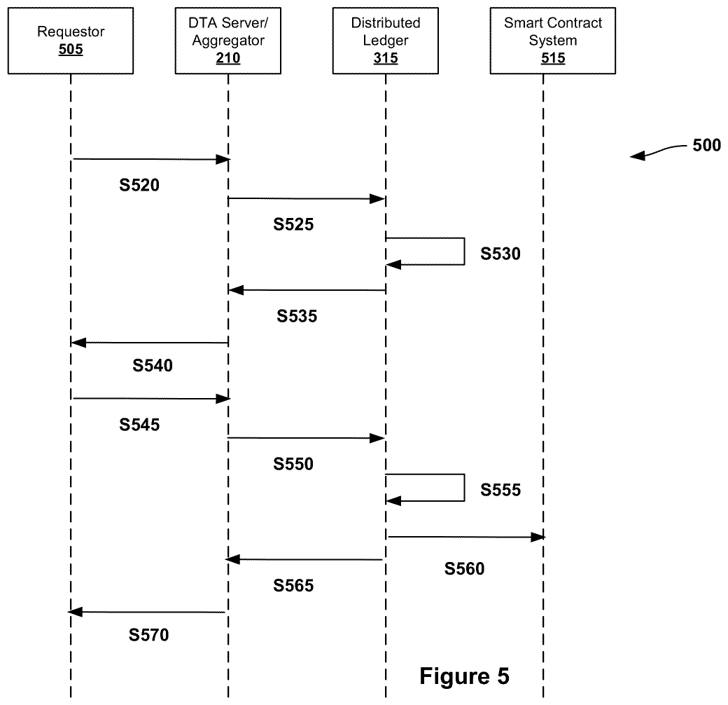

In some further embodiments, the authenticated network elements 125 indicate they are trusted network elements 120 and thus may be deployed to work with other authenticated network elements 125 securely. In these embodiments, groups of authenticated network elements 125 may be linked together in such a way to be considered an authenticated series or group of network elements 120. These groups of network elements 120 may then be assigned to work together as a group, such as in process 500 (shown in FIG. 5).

FIG. 5 illustrates a timing diagram of a process 500 for gaining access to one or more network elements 120 (shown in FIG. 1) on the network 100 (shown in FIG. 1). In the example embodiment, process 500 is used when an entity desires to access one or more network elements 120. For example, process 500 would be used when an entity is requesting to build the path from end point A 105 to end point B 110. Process 500 may also be used for reserving network elements 120 to be used at a subsequent point in time.

In the example embodiment, the requestor, using a computer device, 505 transmits S520 a message to an aggregator/DTA server 210. In some embodiments, the requestor 505 is the participant 305 (shown in FIG. 3). In some further embodiments, the requestor 505 is associated with the MNO server 215 (shown in FIG. 2). The requestor 505 is responsible for transmitting data. In some embodiments, the DTA server 210 is also known as an aggregator 210 for aggregating information about the network 100.

In the example embodiment, the DTA server 210 transmits S525 a request to the distributed ledger 315. In the example embodiment, the request is for a network experience, such as a network slice. The request also includes a start time and an end time. The network experience could be as short as a phone call, a file transfer, or a video conference. The network experience could be for a multi-day conference. Or the network experience could be for a long period of time, such as a month or more. The request includes at least two end points, such as end points A and B 105 and 110 (both shown in FIG. 1). The request may also include a desired maximum cost for reserving the network elements 120 to complete the request. In some embodiments, the DTA server 210 tracks the available network elements by polling the distributed ledger 315 on a periodic basis. In these embodiments, the request also includes a list of desired network elements 120 to be used for the request.

In the example embodiment, the request also includes preferences or requirements for the implementation of the request. These preferences or requirements may include, but are not limited to, minimum certification required, one or more required certification attributes, disallowed software or hardware, disallowed software or hardware versions, required functions, who or which algorithm authenticated the network element 120, disallowed SBOM attributes, disallowed locations in the supply chain, and/or any other desired preferences or requirements. In some embodiments, the preferences and requirements only allow authenticated network elements 125 to be used for the network experience.

In the example embodiment, the distributed ledger 315 analyzes S530 the request and compares the request to the information that it has stored about the network elements 120. The distributed ledger 315 determines the appropriate network elements 120 to complete the request. This includes making changes and/or substitutions based upon availability of different network elements 120 during the requested time period. The distributed ledger 315 transmits S535 a response to the DTA server 210, which is then forwarded S540 to the requestor 505. The requestor 505 replies S545 to the response, either approving to response or denying it. The DTA server 210 forwards S550 the response to the distributed ledger 315.

If the network elements 120 are no longer available or the requestor 505 denied the response, the distributed ledger 315 returns to step S530 and re-analyzes the request and the status of network elements 120. The distributed ledger 315 generates and transmits S535 a new response. This loop continues until the requestor 505 approves a response or cancels the request.

If the network elements in the response are still available, the distributed ledger 315 reserves S555 the network elements 120. The distributed ledger 315 works with a smart contract system 515 to generate S560 a smart contract for the request and the reserved network elements 120. In the example embodiment, the smart contract is stored in an immutable data structure, such as the distributed ledger 315 or another distributed ledger. By using the smart contracts to reserve network elements 120, the network elements 120 are allowed to do certain things for certain people during certain time windows. A particular network element 120 may be reserved by a dozen different users at different points in time and still be available to be used at non-reserved points in time.

The distributed ledger 315 also transmits S565 confirmation to the DTA server 210, which forwards S570 the confirmation to the requestor 505. The confirmation may also include information about or a link to the smart contract.

In the example embodiment, the level of trust required for using a network element 120 depends on the user. For example, a government entity could require a significantly higher level of trust for network elements 120 than an individual consumer. Also a corporation could require a first level of trust for network elements 120 for most communications, but require a significantly higher level of trust for other communications.

The systems and methods herein allow for prioritizing access to network elements 120, where authenticated network elements 125 could require higher levels of priority to access. Furthermore, the cost to use those authenticated network elements 125 could be higher than unauthenticated network elements 130 or authenticated network elements 125 with lower levels of trust.

While the above systems and methods have been described using 5G terms, one having skill in the art would understand that the present systems and methods may also be used for other network types, including both wired and wireless networks.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

At least one of the technical solutions to the technical problems provided by this system may include: (i) improved network security; (ii) improved authentication of network elements; (iii) maintaining authentication in real-time; (iv) providing known secure devices and elements for network usage; and/or (v) updated network mapping.

The methods and systems described herein may be implemented using computer programming or engineering techniques including computer software, firmware, hardware, or any combination or subset thereof, wherein the technical effects may be achieved by performing at least one of the following steps: a) store plurality of records for a plurality of network elements, wherein each record of the plurality of records includes a current status of the corresponding network element of the plurality of network elements; b) receive a request for a set of network elements for data transmission; c) scan the plurality of records for a plurality of available network elements for the request; d) select a first set of network elements to meet the request from the plurality of network elements based upon the current status of each of the plurality of available network elements; e) generate a response to the request based upon the first set of network elements; f) receive a confirmation of the response; g) configure the first set of network elements to complete the data transmission; h) wherein the plurality of records are stored in a digital ledger; i) wherein the request is for a subsequent time and wherein the first set of network elements are reserved at the subsequent time; j) wherein the current status for each network element includes a certification status for each network element; k) wherein the certification status includes certified and not certified, wherein a certified status includes a digital certificate associated with the network element; l) wherein the digital certificate is configured to expire after a period of time; m) wherein the certification status includes a plurality of levels of certified, and wherein each of the plurality of levels of certified is associated with different certification requirements, n) wherein each of the plurality of levels of certified is associated with a different digital certificate; o) wherein the certification status is based upon the network element meeting a plurality of requirements and being authenticated; p) wherein the current status includes at least a software version for the network element; q) generate a smart contract to reserve the first set of network elements to complete the data transmission; r) receive an update to a current status of a first network element of the plurality of network elements; s) validate the update to the current status of the first network element; t) assign a digital certificate to the first network element based upon the validation of the current statis of the first network element; u) store the digital certificate and the update to the current status of the first network element; v) receive a new network element to add to the plurality of network elements, wherein the new network element includes a current status of the new network element; w) validate the current status of the new network element; x) assign a digital certificate to the new network element based upon the validation of the current statis of the new network element; and y) generate a record to store the digital certificate and the current status of the new network element with the plurality of records.

The computer-implemented methods discussed herein may include additional, fewer, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

The aspects described herein may be implemented as part of one or more computer components such as a client device and/or one or more back-end components, such as a cloud service server, for example. Furthermore, the aspects described herein may be implemented as part of computer network architecture and/or a cognitive computing architecture that facilitates communications between various other devices and/or components. Thus, the aspects described herein address and solve issues of a technical nature that are necessarily rooted in computer technology.

Furthermore, the embodiments described herein improve upon existing technologies, and improve the functionality of computers, by improving the security of provisioning devices and preventing their access to the network before they are fully provisioned. The present embodiments improve the speed, efficiency, and accuracy in which such calculations and processor analysis may be performed. Due to these improvements, the aspects address computer-related issues regarding efficiency over conventional techniques. Thus, the aspects also address computer related issues that are related to computer security, for example.

Accordingly, the innovative systems and methods described herein are of particular value within the realm of secure Internet communications. The present embodiments enable more reliable security during the device provisioning process, but without compromising data and speed. Furthermore, according to the disclosed techniques, user computer devices are better able to ensure the security of websites and other connected devices, and thereby protecting computer devices from malicious actors.

Exemplary embodiments of systems and methods for provisioning devices are described above in detail. The systems and methods of this disclosure though, are not limited to only the specific embodiments described herein, but rather, the components and/or steps of their implementation may be utilized independently and separately from other components and/or steps described herein.

Although specific features of various embodiments may be shown in some drawings and not in others, this is for convenience only. In accordance with the principles of the systems and methods described herein, any feature of a drawing may be referenced or claimed in combination with any feature of any other drawing.

Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an application specific integrated circuit (ASIC), a programmable logic circuit (PLC), a programmable logic unit (PLU), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are exemplary only, and thus are not intended to limit in any way the definition and/or meaning of the term processor and processing device.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for dynamic trust-based network architectures, the system comprising a computer device comprising at least one processor in communication with at least one memory device, wherein the at least one processor is programmed to:
store plurality of records for a plurality of network elements, wherein each record of the plurality of records includes a current status of the corresponding network element of the plurality of network elements;
receive a request for a set of network elements for data transmission;
scan the plurality of records for a plurality of available network elements for the request;
select a first set of network elements to meet the request from the plurality of network elements based upon the current status of each of the plurality of available network elements;
generate a response to the request based upon the first set of network elements;
receive a confirmation of the response; and
configure the first set of network elements to complete the data transmission.

2. The system of claim 1, wherein the plurality of records are stored in a digital ledger.

3. The system of claim 1, wherein the request is for a subsequent time and wherein the first set of network elements are reserved at the subsequent time.

4. The system of claim 1, wherein the current status for each network element includes a certification status for each network element.

5. The system of claim 4, wherein the certification status includes certified and not certified, wherein a certified status includes a digital certificate associated with the network element.

6. The system of claim 5, wherein the digital certificate is configured to expire after a period of time.

7. The system of claim 4, wherein the certification status includes a plurality of levels of certified, and wherein each of the plurality of levels of certified is associated with different certification requirements.

8. The system of claim 7, wherein each of the plurality of levels of certified is associated with a different digital certificate.

9. The system of claim 4, wherein the certification status is based upon the network element meeting a plurality of requirements and being authenticated.

10. The system of claim 1, wherein the current status includes at least a software version for the network element.

11. The system of claim 1, wherein the at least one processor is further programmed to generate a smart contract to reserve the first set of network elements to complete the data transmission.

12. The system of claim 1, wherein the at least one processor is further programmed to:
receive an update to a current status of a first network element of the plurality of network elements;
validate the update to the current status of the first network element;
assign a digital certificate to the first network element based upon the validation of the current statis of the first network element; and
store the digital certificate and the update to the current status of the first network element.

13. The system of claim 1, wherein the at least one processor is further programmed to:
receive a new network element to add to the plurality of network elements, wherein the new network element includes a current status of the new network element;
validate the current status of the new network element;
assign a digital certificate to the new network element based upon the validation of the current statis of the new network element; and
generate a record to store the digital certificate and the current status of the new network element with the plurality of records.

14. A method for dynamic trust-based network architectures, the implemented by a computer device comprising at least one processor in communication with at least one memory device, wherein the method comprises:
storing plurality of records for a plurality of network elements, wherein each record of the plurality of records includes a current status of the corresponding network element of the plurality of network elements;
receiving a request for a set of network elements for data transmission;
scanning the plurality of records for a plurality of available network elements for the request;
selecting a first set of network elements to meet the request from the plurality of network elements based upon the current status of each of the plurality of available network elements;
generating a response to the request based upon the first set of network elements;
receiving a confirmation of the response; and
configuring the first set of network elements to complete the data transmission.

15. The method of claim 14, wherein the plurality of records are stored in a digital ledger.

16. The method of claim 14, wherein the request is for a subsequent time and wherein the first set of network elements are reserved at the subsequent time.

17. The method of claim 14, wherein the current status for each network element includes a certification status for each network element, wherein the certification status includes certified and not certified, wherein a certified status includes a digital certificate associated with the network element, and wherein the digital certificate is configured to expire after a period of time.

18. The method of claim 14, wherein the current status for each network element includes a certification status for each network element, wherein the certification status includes a plurality of levels of certified, and wherein each of the plurality of levels of certified is associated with different certification requirements.

19. The method of claim 14 further comprising:
receiving an update to a current status of a first network element of the plurality of network elements;
validating the update to the current status of the first network element;
assigning a digital certificate to the first network element based upon the validation of the current statis of the first network element; and
storing the digital certificate and the update to the current status of the first network element.

20. The method of claim 14 further comprising:
receiving a new network element to add to the plurality of network elements, wherein the new network element includes a current status of the new network element;
validating the current status of the new network element;
assigning a digital certificate to the new network element based upon the validation of the current statis of the new network element; and
generating a record to store the digital certificate and the current status of the new network element with the plurality of records.
